(19) United States
(12) Patent Application Publication
(10) Pub. No.: US 2013/0056908 A1
(43) Pub. Date: Mar. 7, 2013

(54) Methods and Apparatuses for Manufacturing Endodontic Obturation Devices Used in Filling Root Canals

(71) Applicants: Charles J. Goodis, Albuquerque, NM (US); Bobby Bennett, Johnson City, TN (US)

(72) Inventors: Charles J. Goodis, Albuquerque, NM (US); Bobby Bennett, Johnson City, TN (US)

(21) Appl. No.: 13/572,103

(22) Filed: Aug. 10, 2012

Related U.S. Application Data
(60) Provisional application No. 61/523,031, filed on Aug. 12, 2011.

(51) Int. Cl. B29C 45/14

(52) U.S. Cl. 264/296

(57) ABSTRACT

A method of manufacturing an endodontic obturation device used in filling root canals includes injecting an endodontic filler material into a mold having a single cavity or a plurality of spaced apart cavities to apply the endodontic filler material to a filler carrier. After the endodontic filler material has set, the endodontic obturation device having the endodontic filler material adhered to the filler carrier is then removed from the mold.

### CROSS REFERENCE TO RELATED APPLICATION

The present application claims priority to U.S. Provisional Application Ser. No. 61/523,031, filed on Aug. 12, 2011, which is expressly incorporated herein in its entirety by reference thereto.

### FIELD OF THE INVENTION

The present invention is related to apparatuses and methods for manufacturing endodontic obturation devices used in filling root canals.

### BACKGROUND

During root canal surgery, after removing tissue from the root canal, the root canal is filled with an obturator applied via an endodontic obturation device. A problem associated with known obturation devices is that substantial cost, time, and labor are required during their manufacture. Thus, there is a need for apparatuses and methods for manufacturing endodontic obturation devices that reduce the cost, time, and labor.

### SUMMARY

In accordance with exemplary embodiments of the present invention, a method of manufacturing a device used for filling one or more root canals includes: providing a mold including at least one cavity, the at least one cavity shaped to have one or more tapers or a constant cross-sectional shape; injecting an endodontic filler material into the at least one cavity; inserting a portion of a respective filler carrier into the at least one cavity after injecting the endodontic filler material into the at least one cavity; and removing the respective filler carrier and filler material from the at least one cavity of the mold after inserting the portion of the respective filler carrier into each of the at least one cavity.

The mold may include only a single cavity or a plurality of cavities corresponding to the at least one cavity.

The filler material may be comprised of gutta percha and/or a composite material. The mold may be formed of silicone. The mold may be comprised of at least one material selected from the group consisting of: metal, silicone, rubber, and plastic.

The filler carrier may be comprised of a material selected from the group consisting of: polymer, gutta percha, a composite material, and metal. The filler carrier may or may not comprise a handle.

The method may also include joining a handle to at least one of (a) the respective filler carrier and (b) the filler material after removing the respective filler carrier and filler material from the at least one cavity of the mold. The method may also include heating and/or chemically curing the filler material. The filler material may be heated gutta percha. The method may include heating the gutta percha to a temperature from about 100° F. to about 1000° F. (or from about 38° C. to about 538° C.) and/or heating the gutta percha for period from about 1 minute to about 24 hours. The filler material may be passively injected into the at least one cavity and/or injected via pressurized injection into the at least one cavity by a nozzle of the injecting device, the nozzle forming a seal with an opening of the at least one cavity.

In accordance with exemplary embodiments of the present invention, a method of manufacturing a device used for filling a root canal(s) includes: providing a mold having at least one cavity, the at least one cavity shaped to have one or more tapers or a constant cross-sectional shape; inserting a portion of a respective filler carrier into each of the at least one cavity; injecting an endodontic filler material into the at least one cavity after inserting the portion of the respective filler carrier into each of the at least one cavity; and removing the respective filler carrier and filler material from each of the at least one cavity of the mold after injecting the endodontic filler material into at least one cavity.

The mold may include only a single cavity or a plurality of cavities corresponding to the at least one cavity.

The filler material may be comprised of gutta percha and/or a composite material. The mold may be formed of silicone. The mold may be comprised of at least one material selected from the group consisting of: metal, silicone, rubber, and plastic.

The filler carrier may be comprised of a material selected from the group consisting of: polymer, gutta percha, a composite material, and metal. The filler carrier may or may not comprise a handle.

The method may also include joining a handle to at least one of (a) the respective filler carrier and (b) the filler material after removing the respective filler carrier and filler material from the at least one cavity of the mold. The method may also include heating and/or chemically curing the filler material. The filler material may be heated gutta percha. The method may include heating the gutta percha to a temperature from about 100° F. to about 1000° F. (or from about 38° C. to about 538° C.) and/or heating the gutta percha for period from about 1 minute to about 24 hours. The filler material may be passively injected into the at least one cavity and/or injected via pressurized injection into the at least one cavity by a nozzle of the injecting device, the nozzle forming a seal with an opening of the at least one cavity.

In accordance with exemplary embodiments of the present invention, a method of manufacturing an endodontic obturation device used for filling root canals includes:

(a) providing a mold with a single cavity or a mold with a plurality of spaced apart cavities with the cavity having a single or multiple tapered or parallel cavity shape (if the mold has a plurality of cavities, the shapes, diameters, and lengths of the cavities may all be the same or have a variety of shapes, diameters, and lengths);

(b) injecting the endodontic filler material into a mold with a single cavity or a mold with a plurality of spaced apart cavities (due to the injecting process, little to no voids are present in the endodontic filler material in the cavity or cavities);

(c) inserting the filler carrier into the mold cavity or cavities after injecting the endodontic filler material into the mold (due to the viscosity of the endodontic filler material and the shape of the cavity or cavities, no additional support is necessary for the filler carrier) (the filler carriers may be placed manually and/or mechanically into the cavity or cavities); and

(d) removing the endodontic obturation device (filler carrier with adhered endodontic filler material) from the cavity or cavities manually and/or mechanically after the endodontic filler material has cooled and is adhered to the filler carrier.

In accordance with exemplary embodiments of the present invention, a method of manufacturing an endodontic obturation device used for filling root canals includes:

(a) providing a mold with a single cavity or a mold with a plurality of spaced apart cavities with the cavity or cavities having a single or multiple tapered or parallel cavity shape (if the mold has a plurality of cavities, the shape, diameters, and lengths of the cavities may all be the same or have a variety of shapes, diameters, and lengths);

(b) inserting the filler carrier into the mold cavity or cavities (due to the shape of the cavity or cavities, no additional support is need for the filler carrier) (the filler carriers may be placed manually and/or mechanically into the cavity or cavities);

(c) injecting the endodontic filler material into a mold with a single cavity or a mold with a plurality of spaced apart cavities with the filler carrier or carriers present in the cavity or cavities (due to the injecting process little to no voids are present in the endodontic filler material in the cavity or cavities); and

(d) removing the endodontic device (filler carrier with adhered endodontic filler material) from the cavity or cavities manually and/or mechanically after the endodontic filler material has cooled and is adhered to the filler carrier.

Further features and aspects of exemplary embodiments of the present invention are described in more detail below with reference to the appended Figures.

### BRIEF DESCRIPTION OF THE DRAWINGS

FIG. 1 shows a top view of the mold with an enlarged inset view of a single cavity in accordance with an exemplary embodiment of the present invention.

FIG. 2 shows a top view of the mold of FIG. 1 with an enlarged inset view of a plurality of spaced apart cavities.

FIG. 3 shows a side view of the mold of FIG. 1.

FIG. 4 shows a side view of the mold of FIG. 2.

FIG. 5 shows a cross-sectional side view of the mold of FIG. 1 showing endodontic filler material being injected into the cavity.

FIG. 6 shows a cross-sectional side view of the mold of FIG. 2 showing the endodontic filler material being injected into the cavities.

FIG. 7 shows a cross-sectional side view of the mold of FIG. 1 showing the endodontic filler material disposed in the mold with the filler carrier being placed into the cavity.

FIG. 8 shows a cross-sectional side view of the mold of FIG. 2 showing the endodontic filler material disposed in the mold with the filler carriers being placed into the cavities.

FIG. 9 shows a cross-sectional side view of the mold of FIG. 1 showing the endodontic filler material disposed in the mold with the filler carrier disposed in the cavity.

FIG. 10 shows a cross-sectional side view of the mold of FIG. 2 showing the endodontic filler material disposed in the mold with the filler carriers disposed in the cavities.

FIG. 11 shows a cross-sectional side view of the mold of FIG. 1 showing the newly formed endodontic obturator device being removed from the cavity.

FIG. 12 shows a cross-sectional side view of the mold of FIG. 2 showing the newly formed endodontic obturator devices being removed from the cavities.

FIG. 13 shows a side view of the newly formed endodontic obturator device of FIG. 11.

FIG. 14 shows a side view of the newly formed endodontic obturator devices of FIG. 12.

FIG. 15 shows a top view of a mold with a single cavity in accordance with an example embodiment of the present invention.

FIG. 16 shows a top view of a mold with a plurality of spaced apart cavities in accordance with an example embodiment of the present invention.

FIG. 17 shows a side view of the mold of FIG. 15 with a single cavity.

FIG. 18 shows a side view of the mold of FIG. 16 with a plurality of spaced apart cavities.

FIG. 19 shows an isometric view of the mold of FIG. 15 in an open state with a filler carrier in the process of being placed into the cavity.

FIG. 20 shows an isometric view of the mold of FIG. 16 in an open state with filler carriers in the process of being placed into the cavities.

FIG. 21 shows a side view of the mold of FIG. 15 showing the filler carrier in the cavity.

FIG. 22 shows a side view of the mold of FIG. 16 showing the filler carriers in the cavities.

FIG. 23 shows a side view of the mold of FIG. 15 with the filler carrier being disposed in the cavity and the endodontic filler material being injected into the cavity.

FIG. 24 shows a side view of the mold of FIG. 16 with the filler carriers being disposed in the cavities and the endodontic filler material being injected into the cavities.

FIG. 25 shows a side view of the mold of FIG. 15 with the filler carrier being disposed in the cavity and the endodontic filler material being disposed in the cavity.

FIG. 26 shows a side view of the mold of FIG. 16 with the filler carriers being disposed in the cavities and the endodontic filler material being disposed in the cavities.

FIG. 27 shows a side view of the mold of FIG. 15 with the newly formed endodontic obturator device being removed from the cavity.

FIG. 28 shows a side view of the mold of FIG. 16 with the newly formed endodontic obturator devices being removed from the cavities.

FIG. 29 shows a side view of the newly formed endodontic obturator device of FIG. 27.

FIG. 30 shows a side view of the newly formed endodontic obturator devices of FIG. 28.

### DETAILED DESCRIPTION

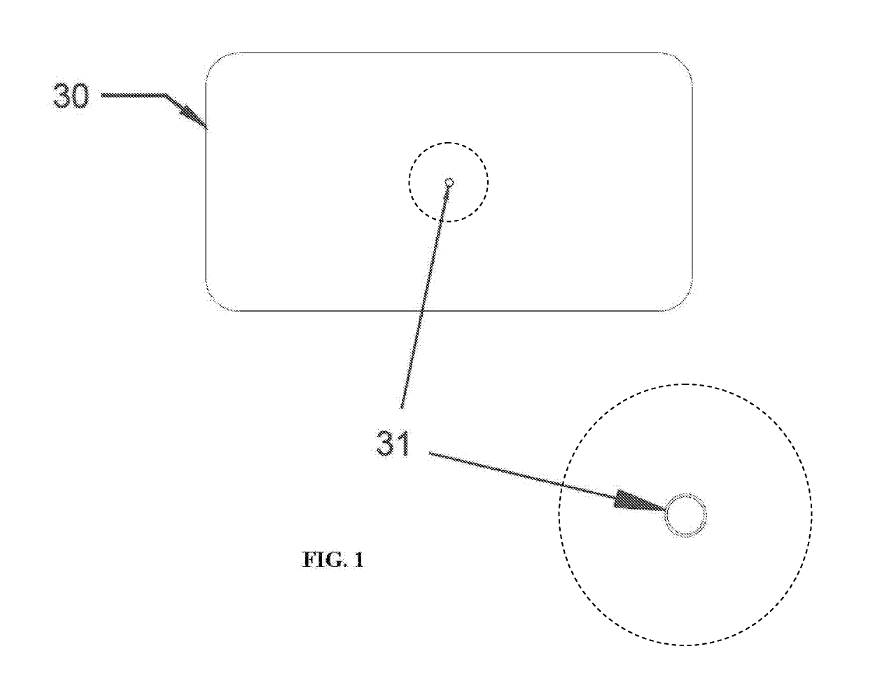

Referring to FIGS. 1 to 30, a method of manufacturing an endodontic obturation device used in filling root canals by injecting an endodontic filler material into a mold having a single cavity or a plurality of spaced apart cavities to apply the endodontic filler material to a filler carrier is illustrated.

FIG. 1 shows a top view of the mold 30 in accordance with an exemplary embodiment of the present invention. The mold 30 may be comprised of metal, silicone, rubber, plastic, and/or any other suitable material(s) (for example, any materials used for making molds in the injection molding industry). The enlarged inset view of FIG. 1 shows a single cavity 31 in the form of a circular hole. This cavity 31 may have a configuration selected from a variety of cross-sectional shapes and other parameters. For example, the cross-section of cavity 31 may be circular, oval, or any other suitable cross-sectional geometry. Moreover, the cavity 31 may have grooves or vents that alter the cross-sectional shape. For example, generally circular or oval cross-sections of cavity 31 may be modified by the provision of grooves or vents, which may, for example, extend longitudinally along the cavity 31.

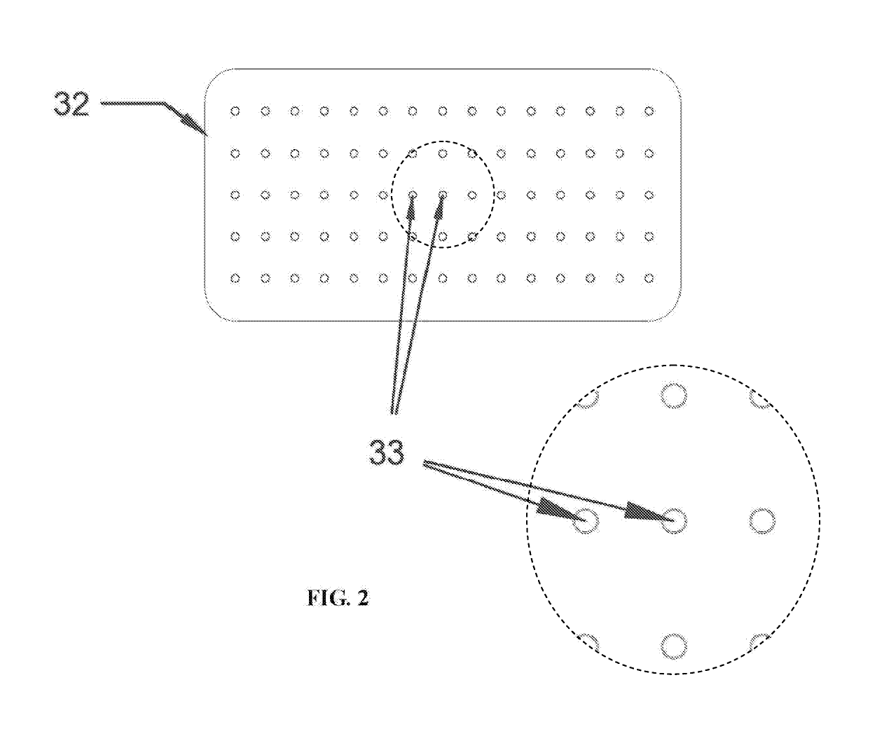

FIG. 2 shows a top view of the mold 32, which may be comprised as the same material(s) described herein with regard to the mold 31 (for example, metal, silicone, rubber, plastic, and/or any other suitable material(s)). The enlarged inset view also shows a plurality of spaced apart cavities 33, each in the form of a circular hole. These cavities 33 may each have the same features as cavity 31 described herein. The mold 32 differs from mold 30 only in that mold 32 includes a plurality of cavities 33, as opposed to the single cavity 31 of mold 30.

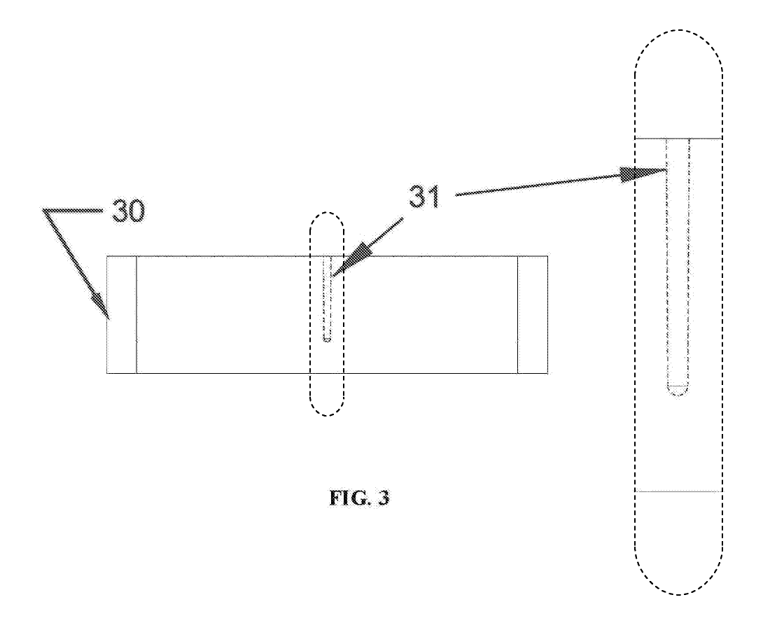

FIG. 3 shows a side view of the mold 30 with a single cavity 31. As indicated above, the cavity 31 may have features selected from a variety of cross-sectional shapes and configurations. Furthermore, the depth of the cavity may be selected from a variety of different depths.

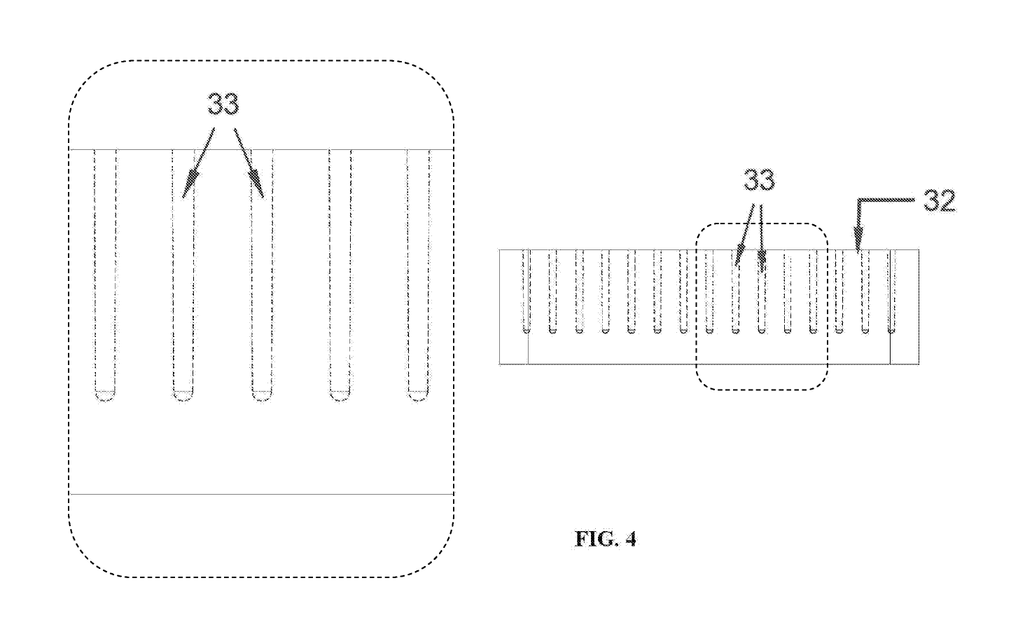

FIG. 4 shows a side view of the mold 32 with an enlarged inset view showing a plurality of spaced apart cavities 33. As indicated above, cavities 33 may have features selected from a variety of cross-sectional shapes and configurations. Furthermore, the depth of each of the cavities 33 may be selected from a variety of different depths.

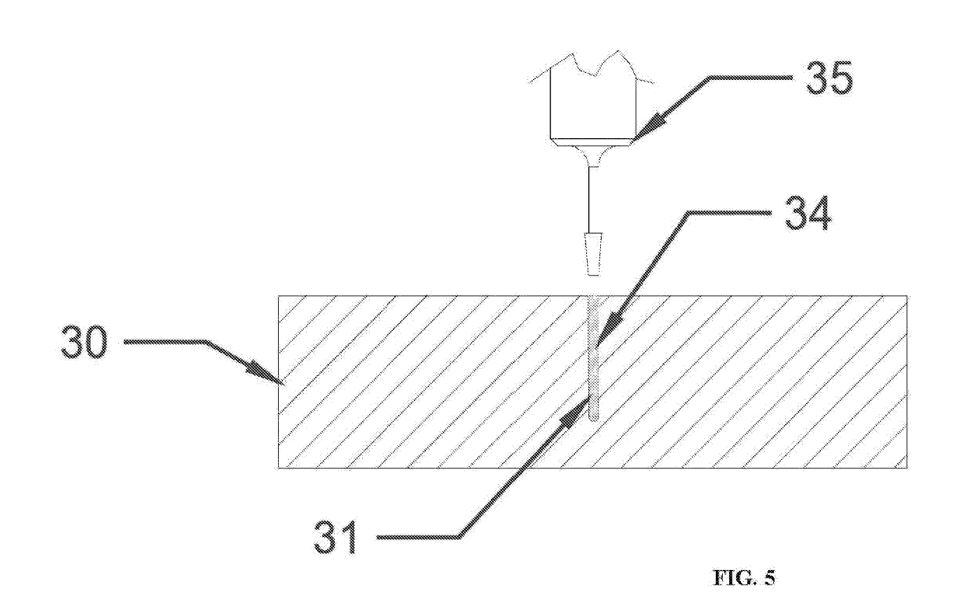

FIG. 5 shows a side view of the mold 30 with a single cavity 31 showing the endodontic filler material 34 being injected into the cavity by the nozzle 35 of an injecting device. The endodontic filler material 34 may be gutta percha, a composite material, and/or other acceptable endodontic filler materials. The filler material 34 may be heated, chemically reacted in an unheated state, and/or chemically reacted in a heated state. The nozzle 35 of an injecting device may be comprised of stainless steel, another metal, a composite material, and/or any other suitable material (for example, any suitable material used in the injection molding industry). The nozzle 35 may inject the filler material 34 passively into the cavity 31 or may form a seal at the opening of the cavity 31 to allow for a pressurized injection of the endodontic filler material 34 into the cavity 31.

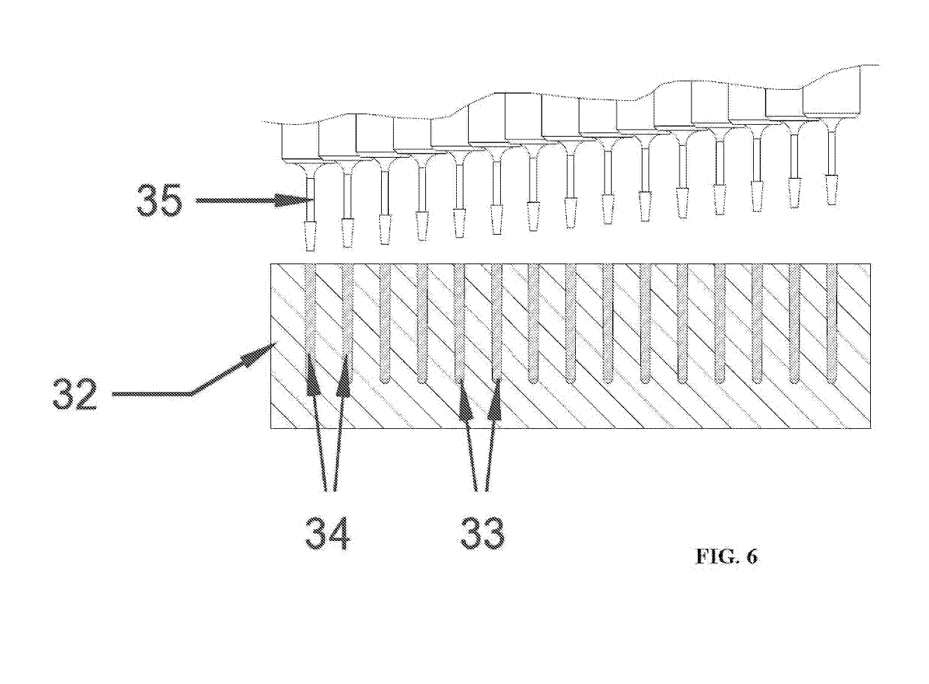

FIG. 6 shows a side view of the mold 32 with a plurality of cavities 33 showing the endodontic filler material 34 being injected into a single cavity of the cavities 33 by nozzles 35 of an injecting device. There may be provided a single nozzle 35 injecting into a single cavity of the cavities 33 or, as shown in FIG. 6, multiple nozzles 35 injecting into multiple cavities 33 at the same or different times.

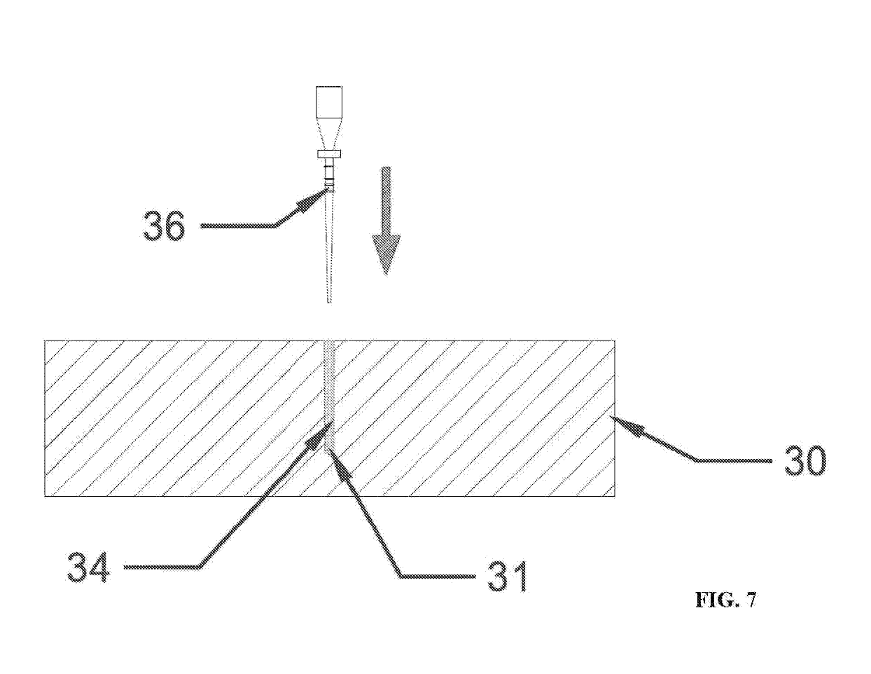

FIG. 7 shows a side view of the mold 30 with a single cavity 31 showing the endodontic filler material 34 in the mold with the filler carrier 36 being moved towards its placement in the cavity 31. The filler carrier 36 may be made of a polymer, gutta percha, composite, metal, and/or other acceptable material used for filling a root canal space. The filler carrier 36 may be placed manually and/or mechanically.

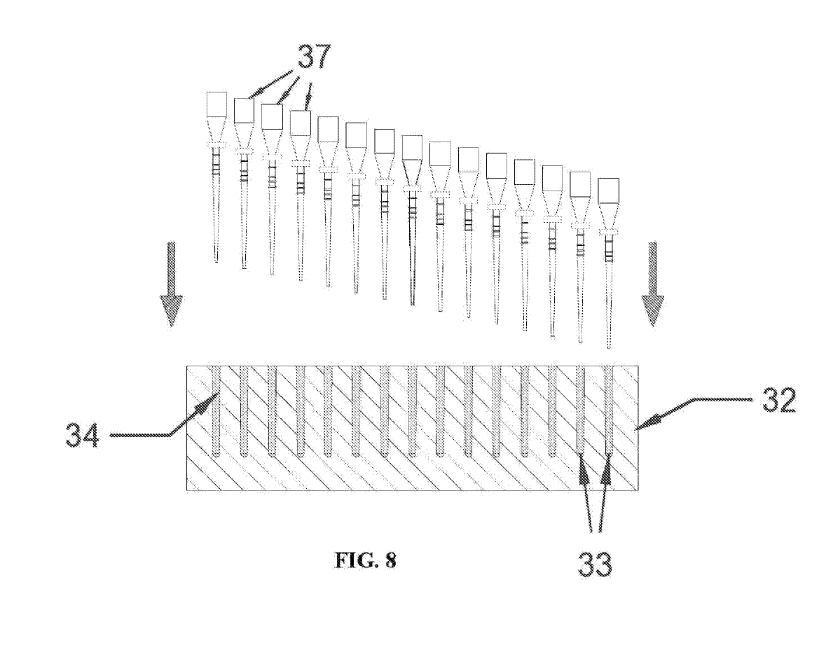

FIG. 8 shows a side view of the mold 32 with a plurality of spaced apart cavities 33 showing the endodontic filler material 34 in the mold with the filler carriers 37 being placed into the cavities. The filler carriers 37 may have the same features as the filler carrier 36 described herein. The filler carriers 37 may be placed simultaneously or sequentially.

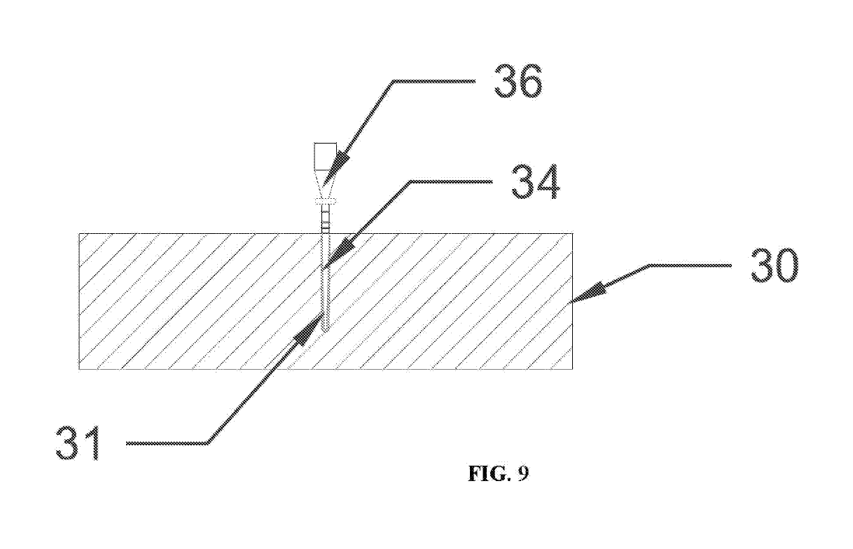

FIG. 9 shows a side view of the mold 30 with the single cavity 31 showing the endodontic filler material 34 in the mold 30 with the filler carrier 36 in the cavity 31. At this stage, the endodontic filler material 34 is allowed to cool and/or chemically set to allow the filler material 34 to adhere to the filler carrier 36.

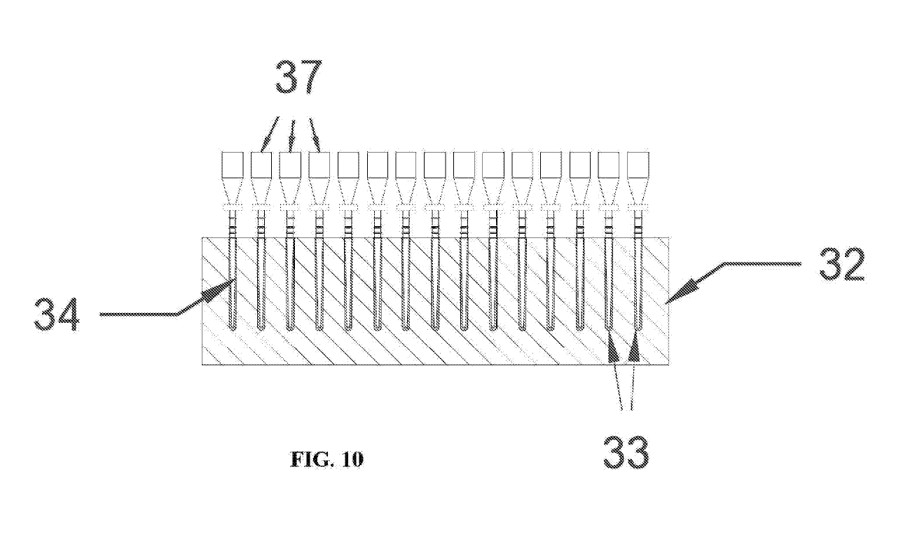

FIG. 10 shows a side view of the mold 32 with a plurality of spaced apart cavities 33 showing the endodontic filler material 34 in the mold 32 with the filler carriers 37 in the cavities 33. At this stage, the endodontic filler material 34 is allowed to cool and/or chemically set to allow the filler material 34 to adhere to the filler carriers 37.

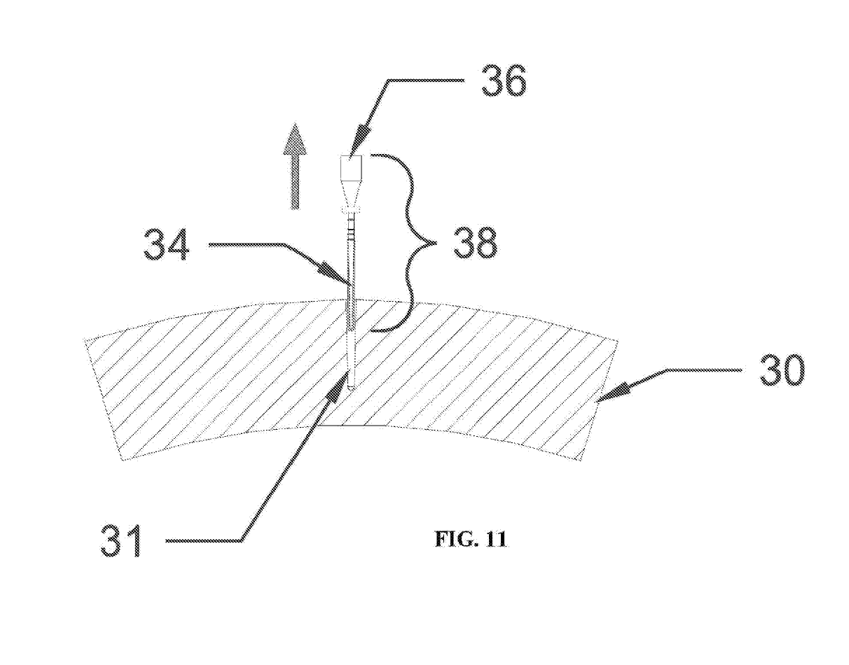

FIG. 11 shows a side view of the mold 30 with the single cavity 31 showing the newly formed endodontic obturator device 38 (i.e., the molded endodontic filler material 34 together with the filler carrier 36 to which the filler material 34 is adhered) being removed from the cavity 31. The endodontic obturator device 38 may be removed manually and/or mechanically from the cavity 31 of the mold 30.

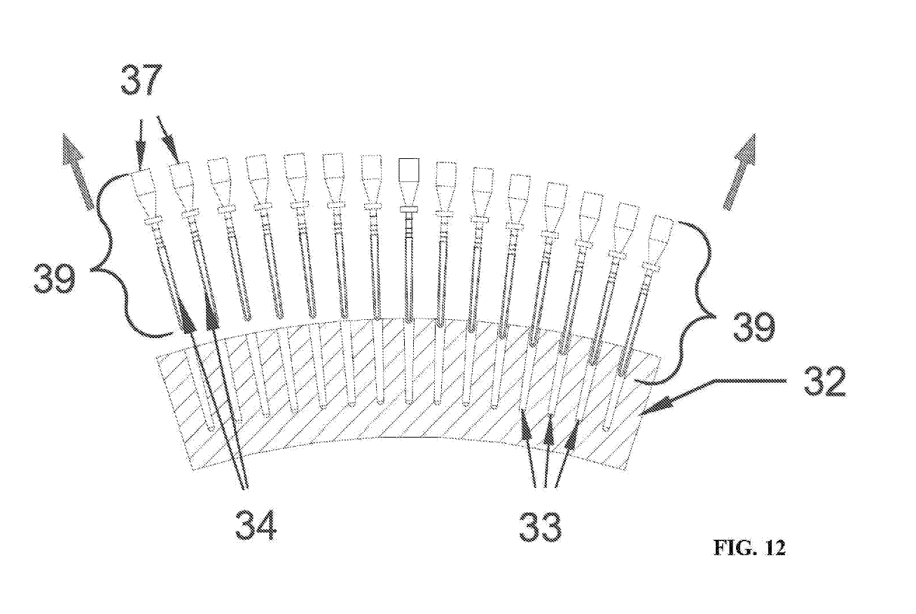

FIG. 12 shows a side view of the mold 32 with the plurality of spaced apart cavities 33, showing the newly formed endodontic obturator devices 39 (i.e., the molded portions of the endodontic filler material 34 together with the filler carriers 37 to which they are respectively adhered) being removed from the cavities 33. Although the obturator devices 39 are shown being removed sequentially, it should be understood that two or more (e.g., all) of the obturator devices 39 may be removed simultaneously. The endodontic obturator devices 39 may be removed manually and/or mechanically from the cavities 33 of the mold 32.

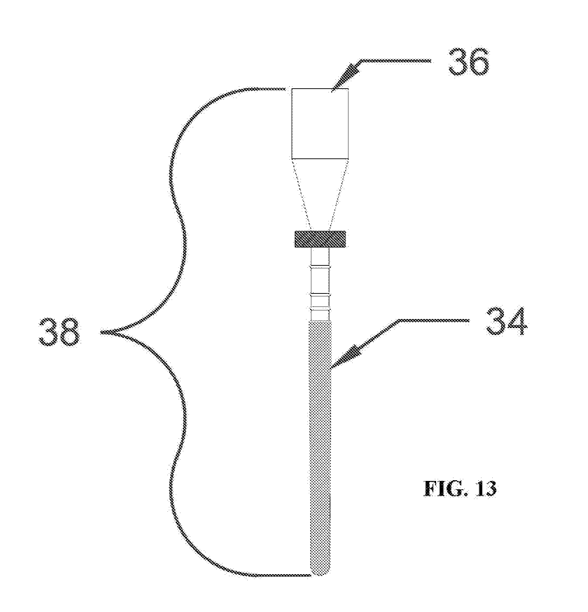

FIG. 13 shows a side view of the newly formed endodontic obturator device 38, with comprises the filler carrier 36 and the endodontic filler material 34 adhered thereto.

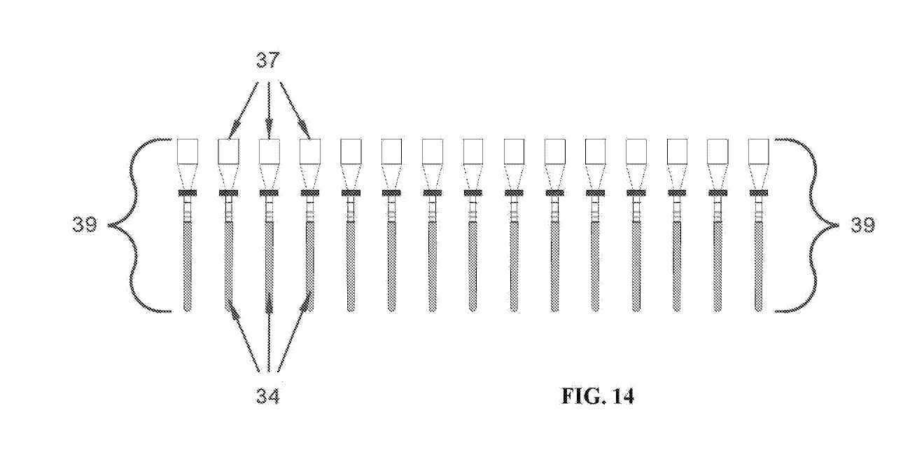

FIG. 14 shows a side view of the newly formed endodontic obturator devices 39, each of which comprises a respective filler carrier 37 and a respective portion of filler material 34 adhered thereto.

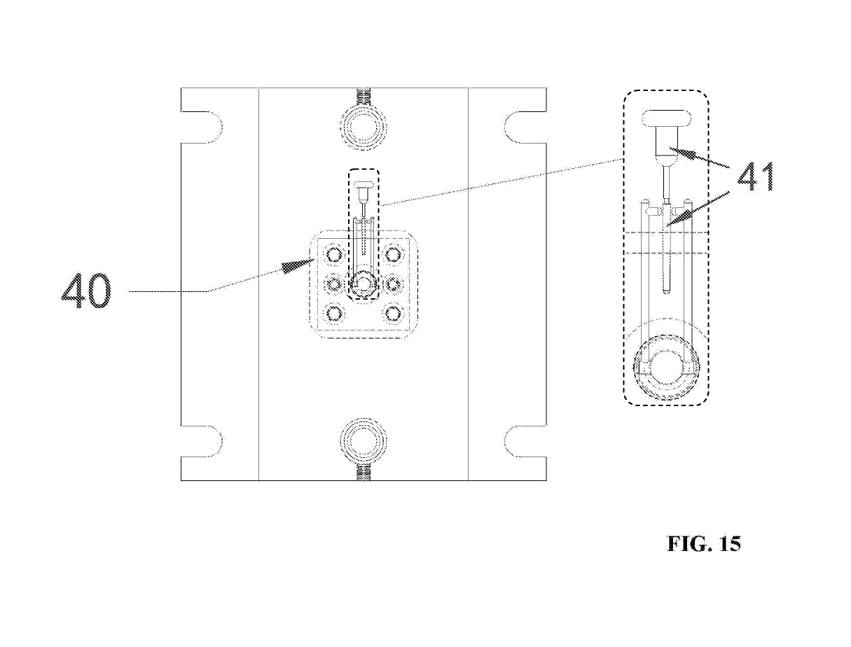

FIG. 15 shows a top view of a mold 40 in accordance with an exemplary embodiment of the present invention. The mold 40 may be comprised of metal, silicone, rubber, plastic, and/or any other suitable material(s) (for example, any materials used for making molds in the injection molding industry). The enlarged inset view of FIG. 15 shows a single cavity 41 in the form of a circular hole. This cavity 41 may have a configuration selected from a variety of cross-sectional shapes and other parameters. For example, the cross-section of cavity 41 may be circular, oval, or any other suitable cross-sectional geometry. Moreover, the cavity 41 may have grooves or vents that alter the cross-sectional shape. For example, generally circular or oval cross-sections of cavity 41 may be modified by the provision of grooves or vents, which may, for example, extend longitudinally along the cavity 41.

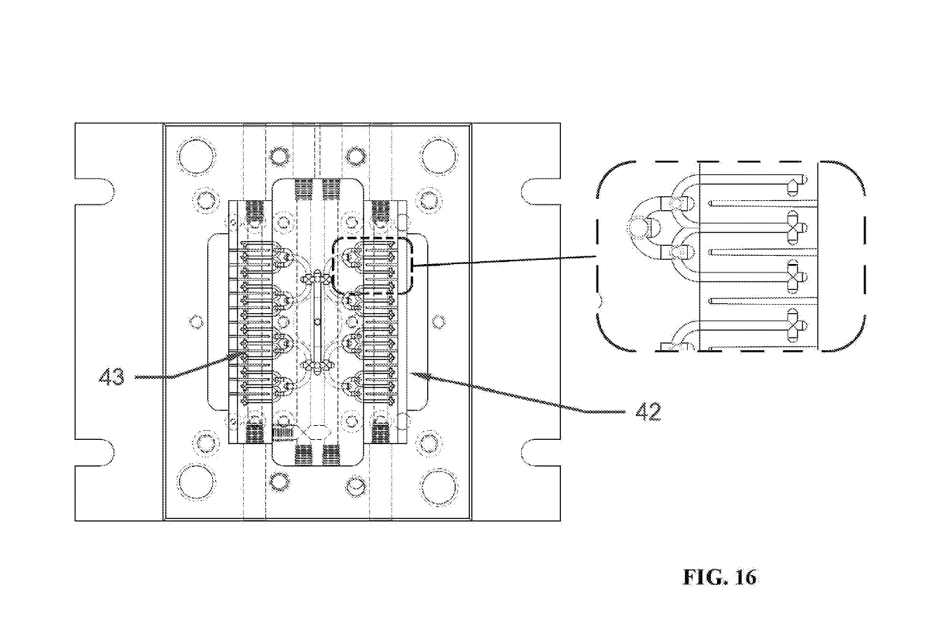

FIG. 16 shows a top view of a mold 42, which may be comprised as the same material(s) described herein with regard to the mold 40 (for example, metal, silicone, rubber, plastic, and/or any other suitable material(s)). The enlarged inset view of FIG. 16 shows a plurality of spaced apart cavities 43 in the form of a circular hole. These cavities 43 may each have the same features as cavity 41 described herein.

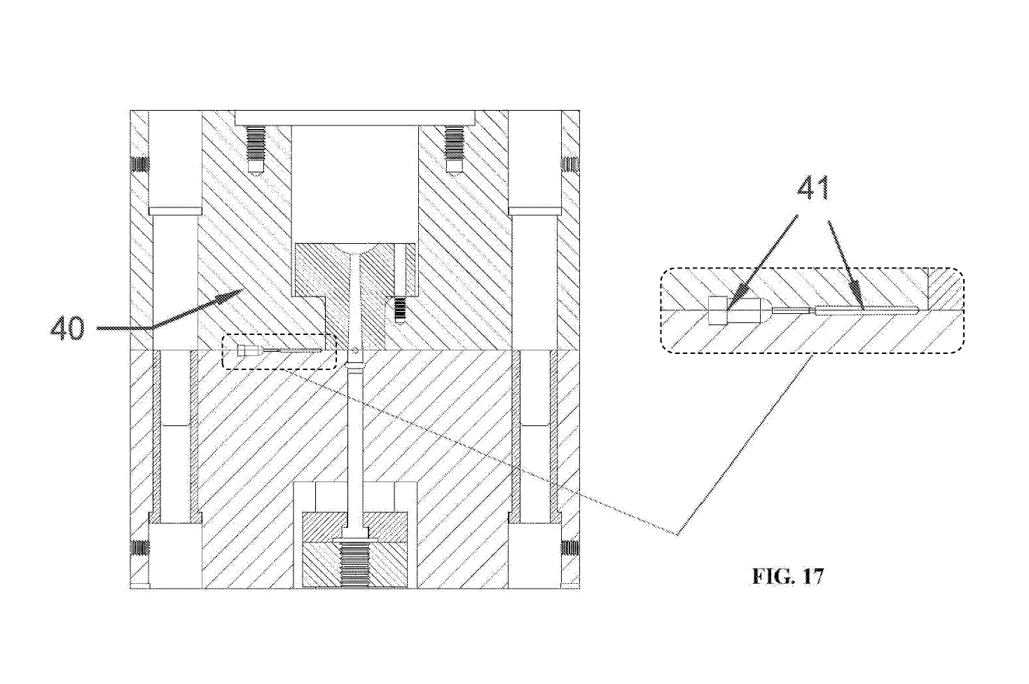

FIG. 17 shows a side view of the mold 40 with the single cavity 41. As indicated above, the cavity 41 may have features selected from a variety of cross-sectional shapes and configurations. Furthermore, the depth of the cavity may be selected from a variety of different depths.

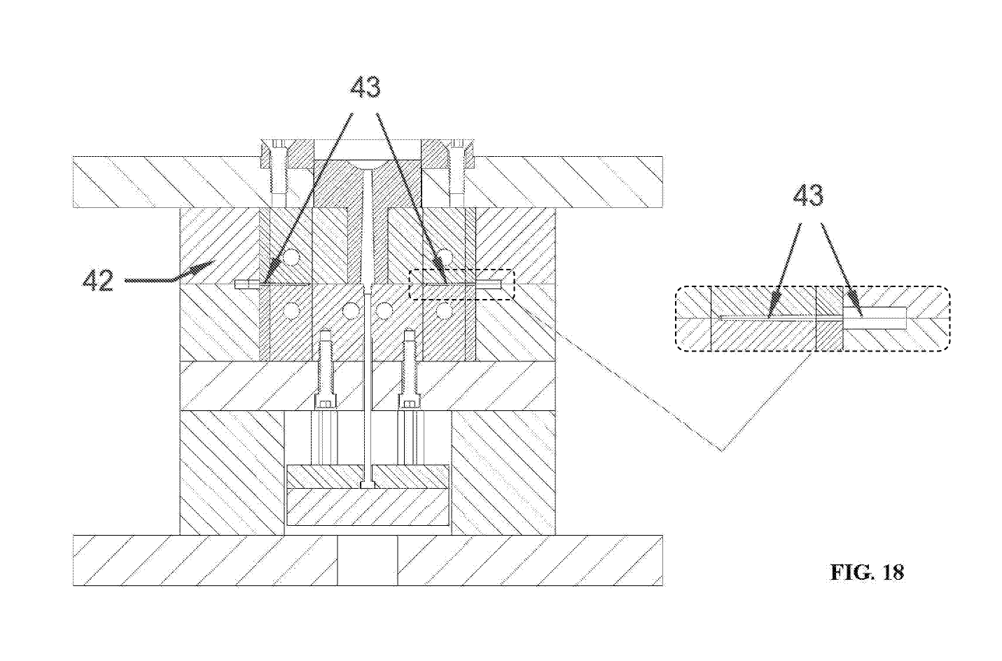

FIG. 18 shows a side view of the mold 42 with the plurality of spaced apart cavities 43. As indicated above, cavities 43 may have features selected from a variety of cross-sectional shapes and configurations. Furthermore, the depth of each of the cavities 43 may be selected from a variety of different depths.

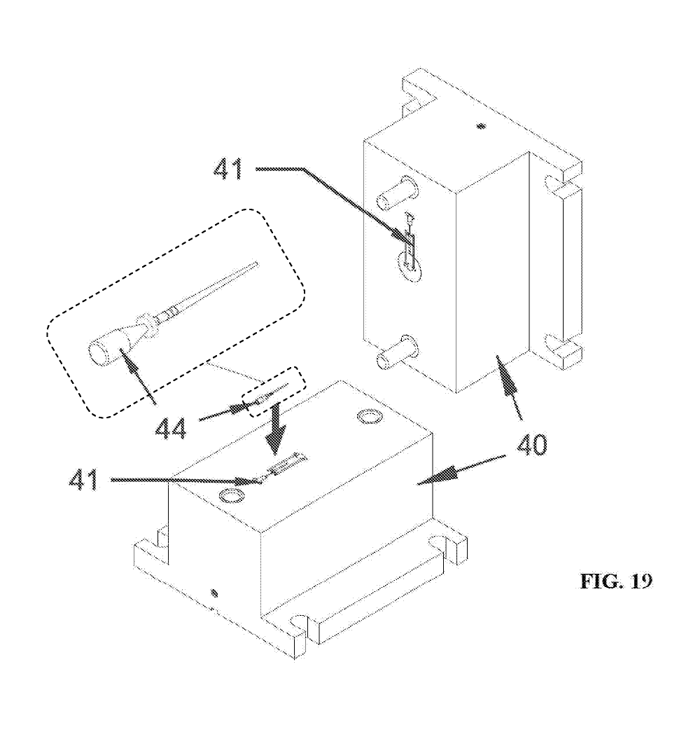

FIG. 19 shows an isometric view of the mold 40 with a single cavity 41 showing the filler carrier 44 being placed into the cavity 41. The filler carrier 44 may be formed of the same material as filler carriers 36 and 37 described herein. For example, filler carrier 44 may be formed of a polymer, gutta percha, composite, metal, and/or other acceptable material used for filling a root canal space. The filler carrier 44 may be placed manually and/or mechanically.

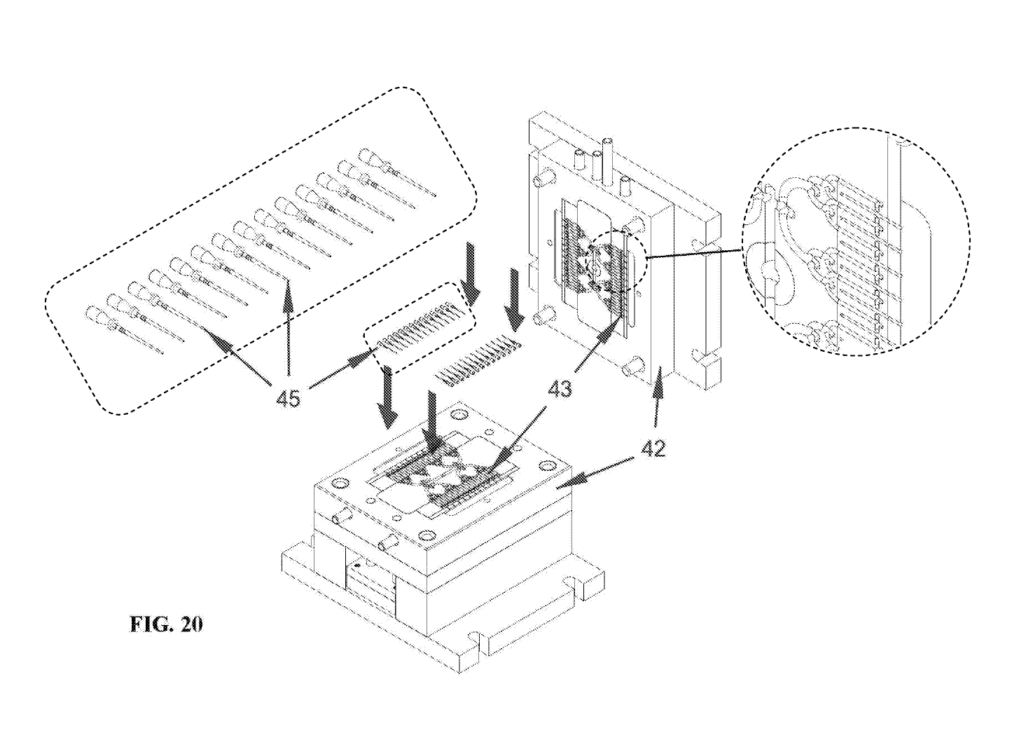

FIG. 20 shows an isometric view of the mold 42 with the plurality of spaced-apart cavities 43 with the filler carriers 45 being placed into the cavities 43.

The filler carriers 45 may be formed of the same material as filler carriers 36, 37, and 44 described herein. For example, filler carrier 45 may be formed of a polymer, gutta percha, composite, metal, and/or other acceptable material used for filling a root canal space. The filler carriers 45 may be placed manually and/or mechanically. The filler carriers 45 may be placed simultaneously or at different times.

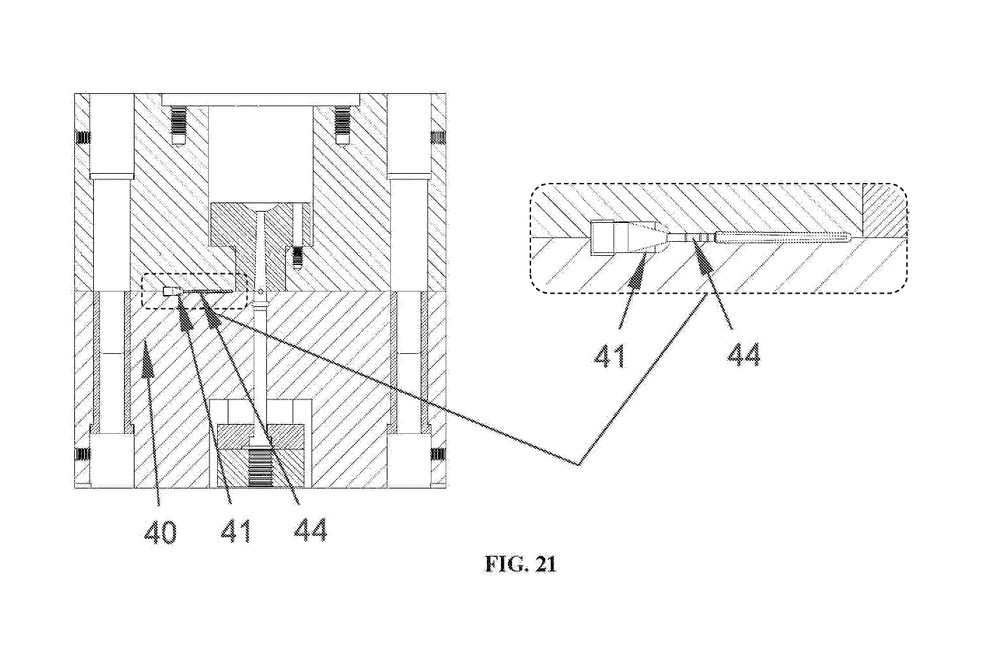

FIG. 21 shows a side view of the mold 40 with a single cavity 41 showing the filler carrier 44 disposed in the cavity 41.

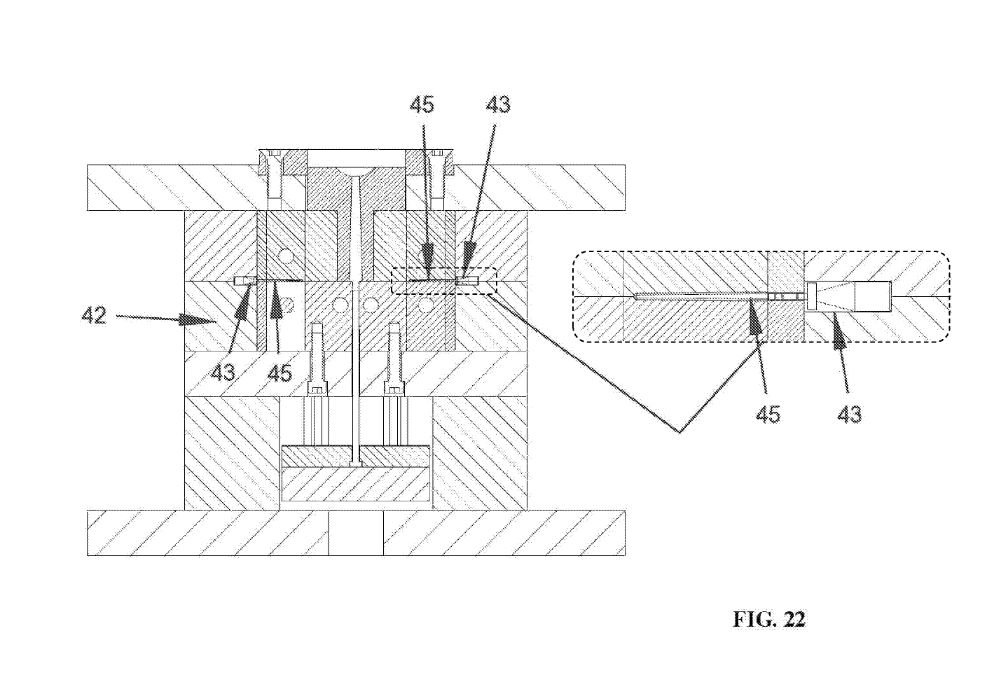

FIG. 22 shows a side view of the mold 42 with a plurality of spaced-apart cavities 43 and shows the filler carriers 45 disposed in the cavities 43.

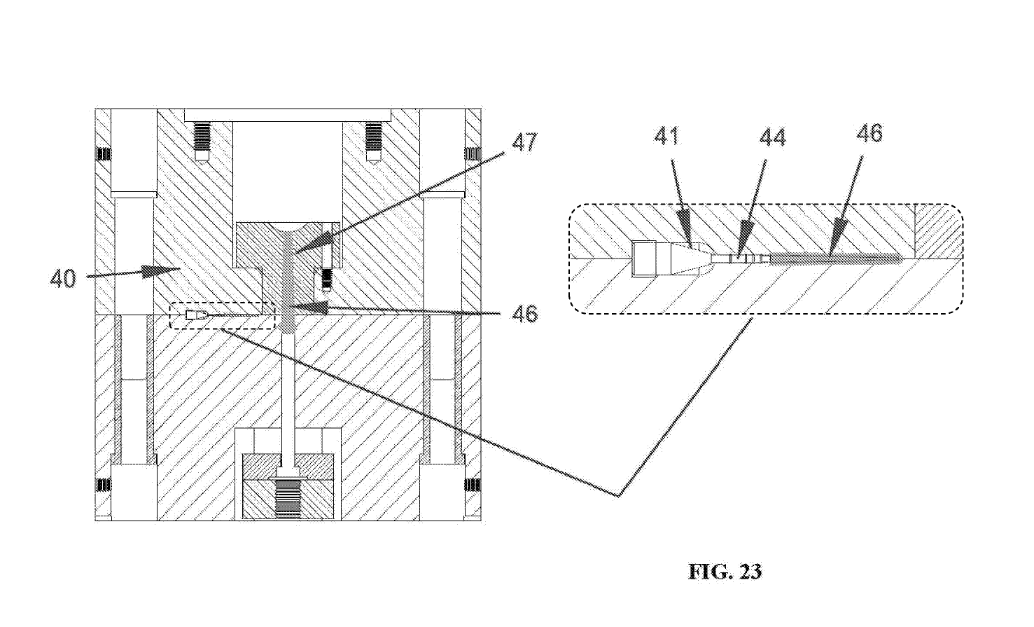

FIG. 23 shows a side view of the mold 40 with a single cavity 41 with the filler carrier 44 disposed in the single cavity 41 and with the endodontic filler material 46 injected into the cavity by the nozzle 47 of an injecting device. The endodontic filler material 46 may the same as the endodontic filler material 34 described herein. For example, the filler material 46 may be gutta percha, a composite material, and/or other acceptable endodontic filler materials. The filler material 46 may be heated, chemically reacted in an unheated state, and/or chemically reacted in a heated state. An injecting device may be made out of stainless steel, another metal, a composite material, and/or any other suitable material (for example, any suitable material used in the injection molding industry). The nozzle 47 may inject the filler material 46 passively into the cavity 41 or may form a seal at the opening of the cavity 41 to allow for a pressurized injection of the endodontic filler material 46 into the cavity 41.

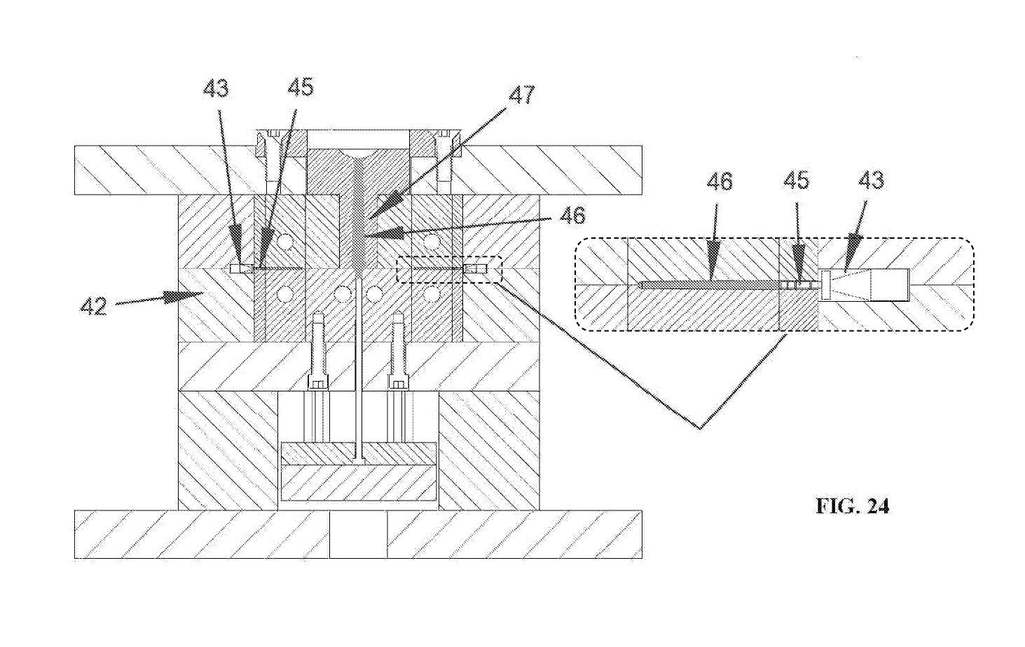

FIG. 24 shows a side view of the mold 42 with the plurality of cavities 43 and the filler carriers 45 disposed in the cavities 43 with the endodontic filler material 46 being injected into a cavity 43 of the cavities 43 by the nozzle 47 of an injecting device. It should be understood that a single nozzle 47 injecting into a single cavity 43 of the cavities 43 (as shown in FIG. 24) or multiple nozzles 47 injecting into multiple cavities 43 at the same or different times may be provided.

The endodontic filler material 46, as indicated above, may be comprised of gutta percha, a composite, or other acceptable endodontic filler materials. As further indicated above, the filler material 46 may be heated, chemically reacted in an unheated state, and/or chemically reacted in a heated state. The nozzle 47 of the injecting device may be comprised of stainless steel, another metal, a composite material, and/or any other suitable material (for example, any suitable material used in the injection molding industry). The nozzle 47 may inject the filler material 46 passively into the cavities 43 or may form a seal at the respective openings of the cavities 43 to allow for a pressurized injection of the endodontic filler material 46 into the cavities 43.

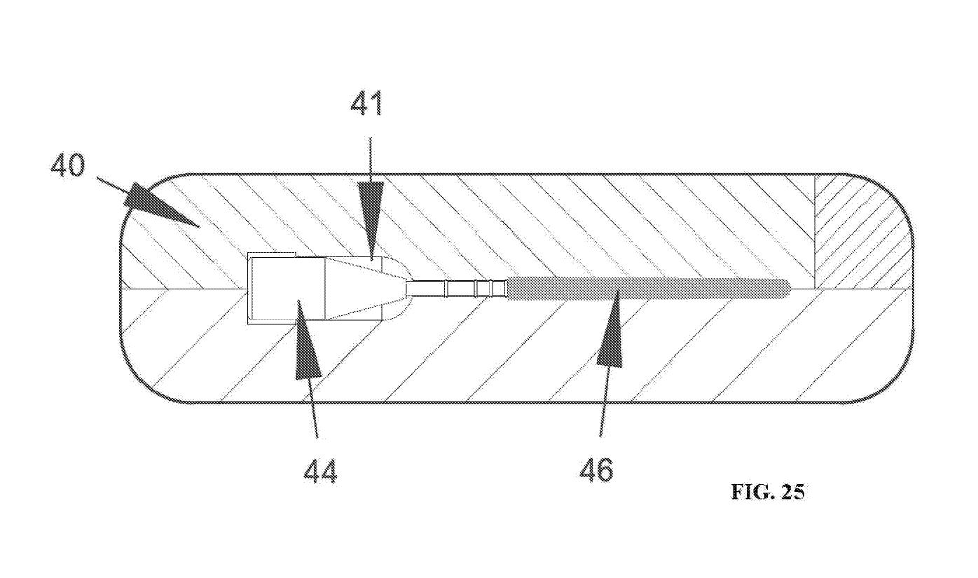

FIG. 25 shows a side view of the mold 40 with a single cavity 41 and the filler carrier 44 disposed in the single cavity 41 and with the endodontic filler material 46 disposed in the single cavity 41. At this stage, the endodontic filler material 46 is allowed to cool and/or chemically set to allow the filler material 46 to adhere to the filler carrier 44.

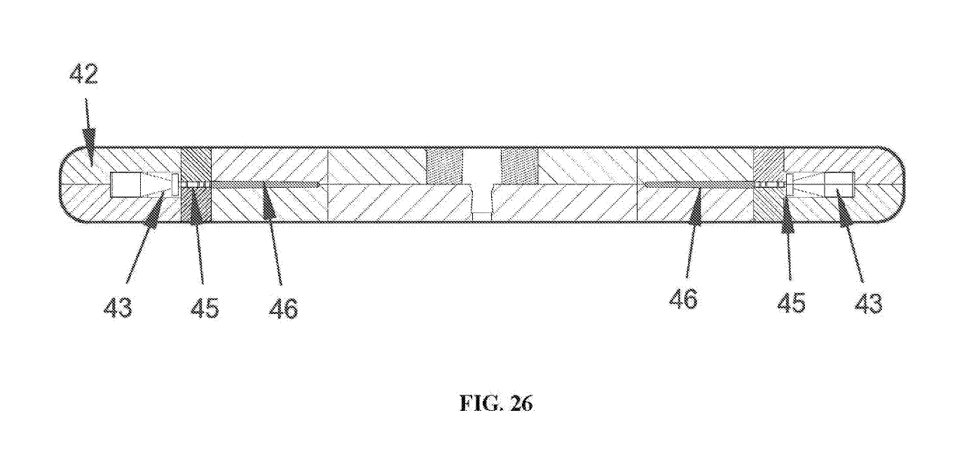

FIG. 26 shows a side view of the mold 42 with a plurality of cavities 43, with the filler carriers 45 disposed in the cavities 43, and with the endodontic filler material 46 disposed in the cavities. At this stage, the endodontic filler material 46 is allowed to cool and/or chemically set to allow the filler material 46 to adhere to the respective filler carriers 45.

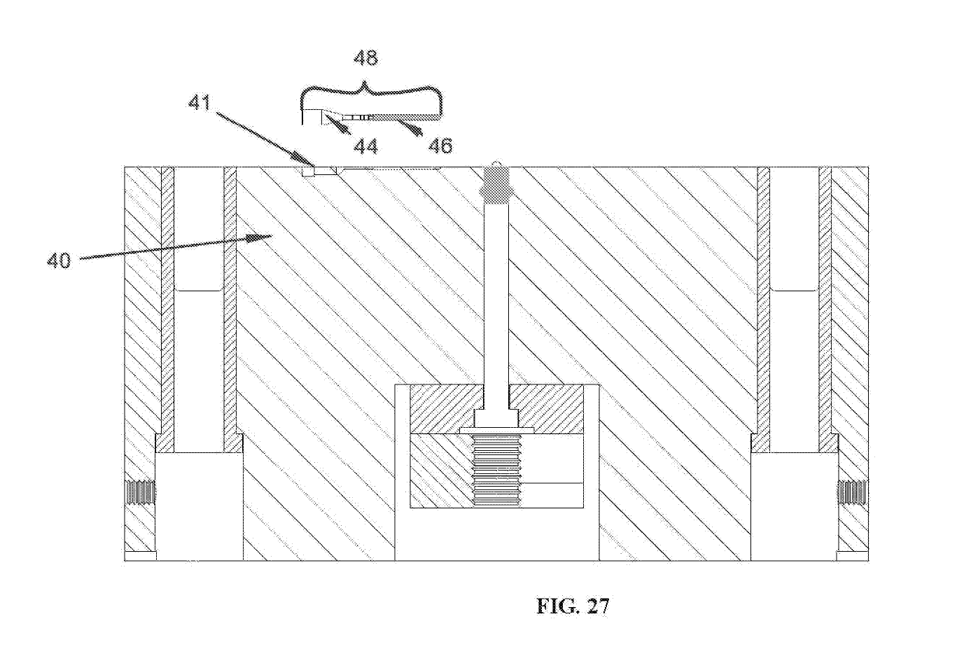

FIG. 27 shows a side view of the mold 40 with the single cavity 41 showing the newly formed endodontic obturator device 48 (i.e., the endodontic filler material 46 together with the filler carrier 44 to which the filler material is adhered) being removed from the cavity 41. The endodontic obturator device 48 may be removed manually and/or mechanically from the mold 40 and cavity 41.

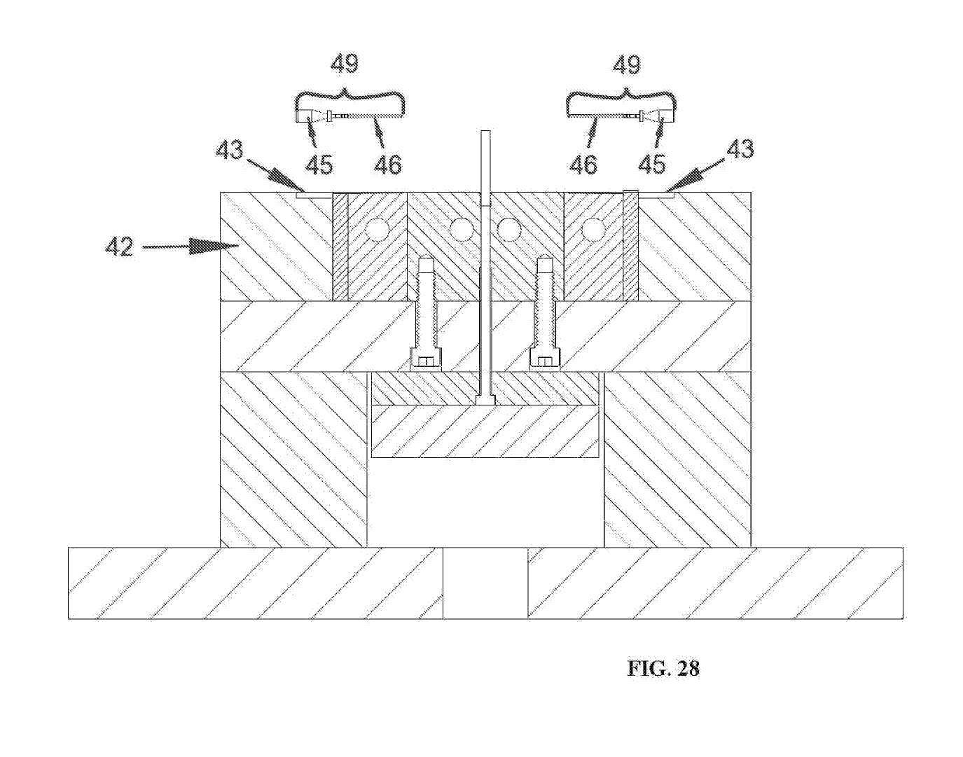

FIG. 28 shows a side view of the mold 42 with a plurality of spaced-apart cavities 43 showing the newly formed endodontic obturator devices 49 (i.e., the respective portions of endodontic filler material 46 together with the respective filler carriers 45 to which the respective portions of filler material 46 are adhered) after being removed from the cavities 43. The endodontic obturator devices 49 may be removed manually and/or mechanically from the mold 42 and cavities 43. Moreover, the obturator devices 49 may be removed simultaneously or at different times.

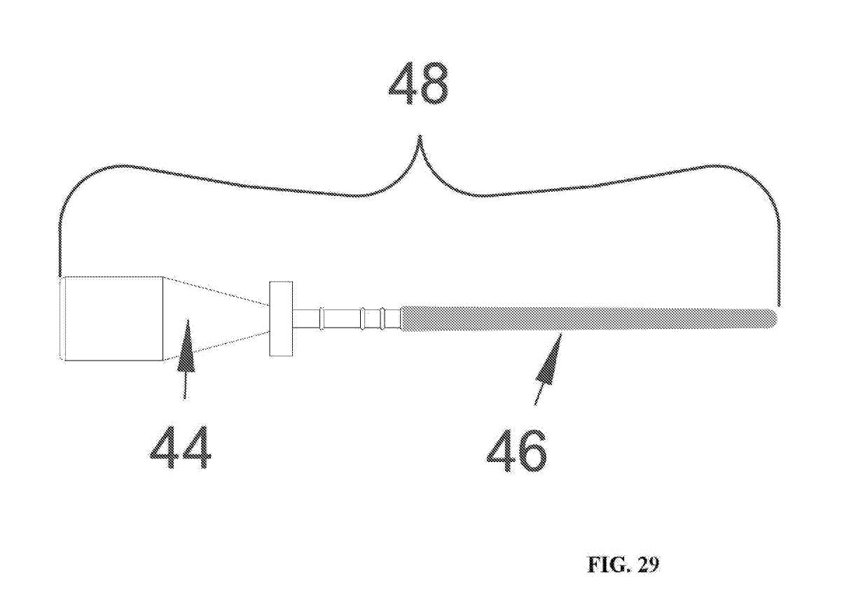

FIG. 29 shows a side view of the newly formed endodontic obturator device 48 (endodontic filler material 46 together with the filler carrier 44.)

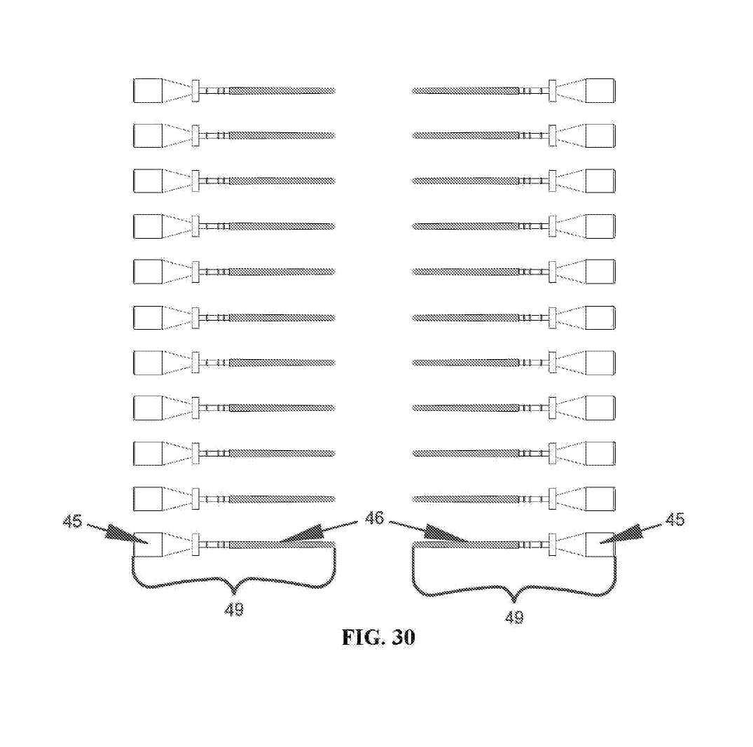

FIG. 30 shows a side view of the newly formed endodontic obturator devices 49 (i.e., the molded portions of endodontic filler material 46 together with the respective filler carriers 45).

Although the present invention has been described with reference to particular examples and exemplary embodiments, the foregoing description is not limiting. Moreover, the apparatus, method, and system described herein may be used in any appropriate combination.

What is claimed is:

1. A method of manufacturing a device used for filling one or more root canals, the method comprising:
providing a mold including at least one cavity, the at least one cavity shaped to have one or more tapers or a constant cross-sectional shape;
injecting an endodontic filler material into the at least one cavity;
inserting a portion of a respective filler carrier into the at least one cavity after injecting the endodontic filler material into the at least one cavity; and
removing the respective filler carrier and filler material from the at least one cavity of the mold after inserting the portion of the respective filler carrier into each of the at least one cavity.

2. The method of claim 1, wherein the mold includes only a single cavity corresponding to the at least one cavity.

3. The method of claim 1, wherein the mold includes a plurality of cavities corresponding to the at least one cavity.

4. The method of claim 1, wherein the filler material is comprised of gutta percha.

5. The method of claim 1, wherein the filler material is formed of a composite material.

6. The method of claim 1, wherein the mold comprises silicone.

7. The method of claim 1, wherein the mold is comprised of at least one material selected from the group consisting of: metal, silicone, rubber, and plastic.

8. The method of claim 1, wherein the filler carrier is comprised of a material selected from the group consisting of: polymer, gutta percha, a composite material, and metal.

9. The method of claim 1, wherein the filler carrier comprises a handle.

10. The method of claim 1, wherein the filler carrier does not comprise a handle.

11. The method of claim 10, further comprising:
joining a handle to at least one of (a) the respective filler carrier and (b) the filler material after removing the respective filler carrier and filler material from the at least one cavity of the mold.

12. The method of claim 1, further comprising:
heating the filler material.

13. The method of claim 1, further comprising:
chemically curing the filler material.

14. The method of claim 1, wherein the filler material is heated gutta percha.

15. The method of claim 14, further comprising:
heating the gutta percha to a temperature from about 100° F. to about 1000° F.

16. The method of claim 14, further comprising:
heating the gutta percha for a period from about 1 minute to about 24 hours.

17. The method of claim 1, wherein the filler material is passively injected into the at least one cavity.

18. The method of claim 1, wherein the filler material is injected via pressurized injection into the at least one cavity by a nozzle of an injecting device, the nozzle forming a seal with an opening of the at least one cavity.

19. A method of manufacturing a device used for filling a root canal(s), the method comprising:
providing a mold having at least one cavity, the at least one cavity shaped to have one or more tapers or a constant cross-sectional shape;
inserting a portion of a respective filler carrier into each of the at least one cavity;
injecting an endodontic filler material into the at least one cavity after inserting the portion of the respective filler carrier into each of the at least one cavity; and
removing the respective filler carrier and filler material from each of the at least one cavity of the mold after injecting the endodontic filler material into at least one cavity.

20. The method of claim 19, wherein the mold includes only a single cavity corresponding to the at least one cavity.

21. The method of claim 19, wherein the mold includes a plurality of cavities corresponding to the at least one cavity.

22. The method of claim 19, wherein the filler material is comprised of gutta percha.

23. The method of claim 19, wherein the filler material is formed of a composite material.

24. The method of claim 19, wherein the mold comprises silicone.

25. The method of claim 19, wherein the mold is comprised of at least one material selected from the group consisting of: metal, silicone, rubber, and plastic.

26. The method of claim 19, wherein the filler carrier is comprised of a material selected from the group consisting of: polymer, gutta percha, a composite material, and metal.

27. The method of claim 19, wherein the filler carrier comprises a handle.

28. The method of claim 19, wherein the filler carrier does not comprise a handle.

29. The method of claim 28, further comprising:
joining a handle to at least one of (a) the respective filler carrier and (b) the filler material after removing the respective filler carrier and filler material from the at least one cavity of the mold.

30. The method of claim 19, further comprising:
heating the filler material.

31. The method of claim 19, further comprising:
chemically curing the filler material.

32. The method of claim 19, wherein the filler material is heated gutta percha.

33. The method of claim 32, further comprising:
heating the gutta percha to a temperature from about 100° F. to about 1000° F.

34. The method of claim 32, further comprising:
heating the gutta percha for a period from about 1 minute to about 24 hours.

35. The method of claim 19, wherein the filler material is passively injected into the at least one cavity.

36. The method of claim 19, wherein the filler material is injected via pressurized injection into the at least one cavity by a nozzle of an injecting device, the nozzle forming a seal with an opening of the at least one cavity.
